(19) United States
(12) Patent Application Publication
(10) Pub. No.: US 2026/0070030 A1
(43) Pub. Date: Mar. 12, 2026

(54) STIRRING BLADE, STIRRING DEVICE, AND STIRRING METHOD

(71) Applicant: SUMITOMO HEAVY INDUSTRIES PROCESS EQUIPMENT CO., LTD., Saijo-shi (JP)

(72) Inventors: Shoji MORINAGA, Saijo-shi (JP); Katsuhide Takenaka, Saijo-shi (JP); Aya Tanaka, Osaka-shi (JP)

(21) Appl. No.: 19/304,478

(22) Filed: Aug. 19, 2025

(30) Foreign Application Priority Data
Sep. 9, 2024 (JP) 2024-155355

(51) Int. Cl. B01F 27/1125

(52) U.S. Cl. CPC B01F 27/1125; B01F 2215/0459

(57) ABSTRACT

A stirring blade that stirs a fluid by rotating around a rotary shaft, in which a flow of the fluid in which a Reynolds number is 300 or more and a ratio of a deformation rate tensor with respect to a velocity gradient tensor of the fluid that is a sum of the deformation rate tensor and a rotational speed tensor is 0.8 or more in a region of 5% or more in the flow is generated.

### CROSS-REFERENCE TO RELATED APPLICATIONS

This application claims priority to Japanese Patent Application No. 2024-155355, filed on Sep. 9, 2024, which is incorporated by reference herein in its entirety.

### BACKGROUND

### Technical Field

Certain embodiments of the present disclosure relate to a stirring blade or the like.

### Description of Related Art

The related art discloses a stirring device including stirring blades that stir a fluid contained in a vertically elongated stirring tank by rotation.

### SUMMARY

According to an embodiment of the present disclosure, there is provided a stirring blade that stirs a fluid by rotating around a rotary shaft, and a flow of the fluid in which a Reynolds number is 300 or more and a ratio of a deformation rate tensor with respect to a velocity gradient tensor of the fluid that is a sum of the deformation rate tensor and a rotational speed tensor is 0.8 or more in a region of 5% or more in the flow is generated.

Another embodiment of the present disclosure is also a stirring blade. The stirring blade is a stirring blade that stirs a fluid by rotating around a rotary shaft, the stirring blade including: two or more and five or less plate-shaped members that are rotatable at two or more and five or less different positions in a radial direction perpendicular to an axial direction in which the rotary shaft extends, in which a spacing in the radial direction between a set of two plate-shaped members adjacent to each other in the radial direction is 1.5 times to 2.5 times a width of at least one of the plate-shaped members in the radial direction.

Still another embodiment of the present disclosure is a stirring device. This device is a stirring device including: a stirring blade that stirs a fluid contained in a stirring tank by rotation, in which the stirring blade generates, within the stirring tank, a flow of the fluid in which a Reynolds number is 300 or more and a ratio of a deformation rate tensor with respect to a velocity gradient tensor of the fluid that is a sum of the deformation rate tensor and a rotational speed tensor is 0.8 or more in a region of 5% or more in the flow.

Yet another embodiment of the present disclosure is a stirring method. This method is a stirring method of stirring a fluid contained in a stirring tank by rotation of a stirring blade, in which a flow of the fluid in which a Reynolds number is 300 or more and a ratio of a deformation rate tensor with respect to a velocity gradient tensor of the fluid that is a sum of the deformation rate tensor and a rotational speed tensor is 0.8 or more in a region of 5% or more in the flow is generated within the stirring tank by the stirring blade.

### BRIEF DESCRIPTION OF THE DRAWINGS

FIG. 1 schematically shows a configuration of a stirring device according to one embodiment.

FIG. 2 schematically shows the configuration of a stirring device according to another embodiment.

FIG. 3 schematically shows the configuration of a stirring device according to still another embodiment.

FIG. 4 schematically shows one small stirring blade in a case where a stirring blade is composed of a combination of a plurality of small stirring blades.

FIG. 5 shows a simulation example of a flow of a fluid F by CFD.

FIG. 6 shows a simulation example of the flow of the fluid F by CFD.

FIG. 7 schematically shows test cases of the number, dimensions, disposition, and the like of one or a plurality of plate-shaped members in each stirring unit constituting the stirring blade.

FIG. 8 shows the results of simulation by CFD for a representative test case as shown in FIG. 7.

FIG. 9 schematically shows a distribution example of fluid particles in which a ratio of a deformation rate tensor E observed or simulated in a preferable test case (a) in FIG. 7 is 0.8 or more.

FIG. 10 schematically shows a distribution example of fluid particles in which the ratio of the deformation rate tensor E observed or simulated in an unfavorable test case (b) in FIG. 7 is 0.8 or more.

### DETAILED DESCRIPTION

In such a stirring device, in order to promote the mass transfer, it is desirable to efficiently apply a shearing force (deforming force) to a fluid. In the related art, a sufficient shearing force is applied to the fluid by increasing the residence time of the fluid in a stirring tank. Therefore, the length of the stirring tank tends to increase. In particular, it is difficult to efficiently apply a shearing force to a fluid having a Reynolds number of 300 or more and having a large inertial force.

The present disclosure has been made in view of such circumstances, and it is desirable to provide a stirring blade or the like that can efficiently apply a shearing force to a fluid having a Reynolds number of 300 or more.

In the present embodiment, for example, in a case where the target is limited to a flow region having a Reynolds number of 300 or more based on fluid analysis or the like such as computational fluid dynamics (CFD), the ratio (0.8 or more) of the deformation rate tensor and the ratio (less than 0.2 or less) of the rotational speed tensor that can not only uniformly mix the fluid but also efficiently apply a shearing force to the fluid to promote the mass transfer, a region or a particle ratio (5% or more) where each ratio should be realized in the flow, and the configuration or shape of the stirring blade that realizes these ratios with a high probability have been specifically found. A specific configuration or shape of the stirring blade that realizes various numerical values at the same time in this way can be designed through simulation or the like based on CFD or the like. Such a stirring blade does not necessarily have to be complicated, and may be configured by a combination of simple plate-shaped members as exemplified below.

Any combination of the above-described components or any conversion of these components into a method, a device, a system, a recording medium, a computer program, or the like is also encompassed by the present disclosure.

Hereinafter, modes (hereinafter, also referred to as embodiments) for carrying out the present disclosure will be described in detail with reference to the drawings. In the description and/or the drawings, the same or equivalent components, members, processes, and the like are denoted by the same reference numerals, and redundant description thereof will be omitted. The scales and shapes of respective parts shown are set for convenience in order to simplify the description, and should not be construed as being limiting unless particularly specified. The embodiments are illustrative, and do not limit the scope of the present disclosure in any way. All the features and the combinations thereof presented in the embodiments are not necessarily essential to the present disclosure. In the embodiments, for convenience, the embodiments are presented by being decomposed into components for each function and/or each function group that realizes the embodiments. However, one component in the embodiments may actually be realized by a combination of a plurality of components that are separate, or a plurality of components in the embodiments may actually be realized by a single integral component. In addition, a plurality of embodiments or modification examples may be disclosed in parallel. However, any components of each embodiment and/or each modification example may be combined in any manner as long as each other's functions are not impaired.

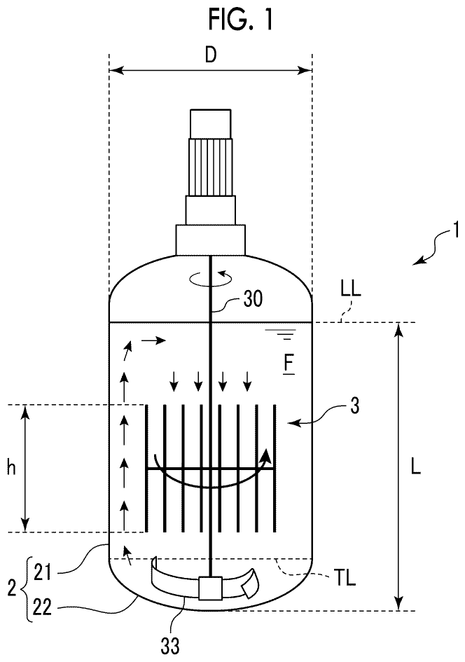

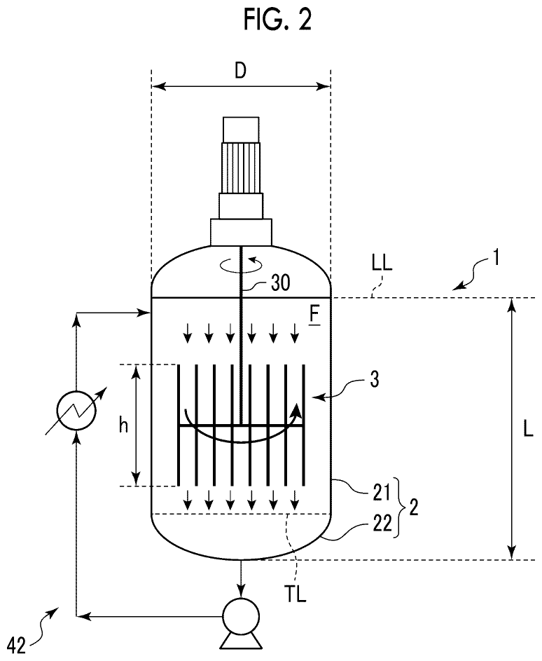

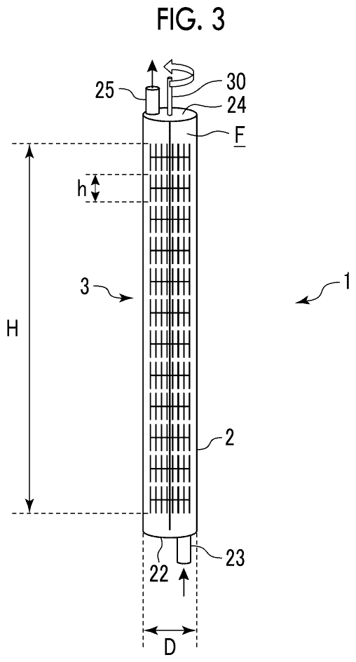

FIG. 1 schematically shows the configuration of a stirring device 1 according to one embodiment of the present disclosure. FIG. 2 schematically shows the configuration of a stirring device 1 according to another embodiment of the present disclosure. FIG. 3 schematically shows the configuration of a stirring device 1 according to still another embodiment of the present disclosure. In the example of each of the embodiments, an up-down direction (or a longitudinal direction or a height direction) in each drawing coincides with the vertical direction, and a left-right direction (or a lateral direction or a width direction) in each drawing coincides with the horizontal direction. In addition, an axial direction in which a center axis of a stirring tank 2 and/or a rotary shaft 30 of a stirring blade 3 extends, which will be described below, coincides with the up-down direction, that is, the vertical direction in each drawing. Furthermore, the left-right direction or the horizontal direction in each drawing is also referred to as a radial direction in order to determine a diameter of the stirring tank 2 or the stirring blade 3. In addition, the up-down direction, the vertical direction, and the axial direction in each drawing may be different from each other. Similarly, the left-right direction, the horizontal direction, and the radial direction in each drawing may be different from each other.

In one embodiment of FIG. 1, the stirring device 1 includes the stirring tank 2 that contains a fluid F as an object to be stirred and the stirring blade 3 that stirs the fluid F in the stirring tank 2 by rotation. The stirring tank 2 includes a cylindrical or tubular straight body portion 21 extending in the axial direction and a bottom portion 22 provided continuous with and below the straight body portion 21. The capacity of the stirring tank 2 is optional.

An inner peripheral wall or a side wall of the straight body portion 21 has a circular cross section in a top view (axial view), and a diameter D thereof represents the tank diameter of the stirring tank 2. In addition, the cross section of the straight body portion 21 in a top view may have any non-circular shape. The tank diameter D of the stirring tank 2 in this case may be defined as the diameter of an inscribed circle of the cross-sectional shape of the straight body portion 21, may be defined as the diameter of a circumscribed circle of the cross-sectional shape, or may be defined as an average value or an intermediate value thereof.

An opening for introducing the fluid F into the stirring tank 2 is provided above the straight body portion 21, or the like. The opening is closed by a lid or the like during the stirring of the fluid F by the stirring blade 3. The fluid F may be supplied into the stirring tank 2 from a supply port such as a supply nozzle (not shown) provided in the side wall or the like of the straight body portion 21.

The bottom portion 22 of the stirring tank 2 is formed in a curved shape that bulges downward from a lower end of the straight body portion 21. A lowermost portion of the stirring tank 2 is formed at a center of the bottom portion 22 by a bulging end having the curved shape. The bottom portion 22 may be formed in an inverted cone shape or an inverted truncated cone shape of which the diameter decreases downward, or may be formed in a flat shape in which the axial direction is a normal direction.

A discharge port (not shown) through which the fluid F after the completion of the stirring can be discharged to the outside of the stirring device 1 may be provided at the lowermost portion of the stirring tank 2. The discharge port may be configured to be openable and closable by a discharge port opening/closing portion such as a valve. For example, when the fluid F is introduced into the stirring tank 2 and stored therein, when the fluid F is stirred by the stirring blade 3, and when the concentration of the fluid F is made uniform, a valve or the like controlled to be in a closed state closes the discharge port. In addition, when the fluid F after the stirring is substantially completed and the concentration thereof is made uniform is discharged while being stirred by the stirring blade 3 as necessary, a valve or the like controlled to be in an open state opens the discharge port. The fluid F after the completion of the stirring may be discharged from the opening in a state where a lid at the top or the like of the stirring tank 2 is open. In addition, the fluid F after the completion of the stirring may be discharged to the outside of the stirring tank 2 from a fluid discharge port such as a discharge nozzle that may be provided on a side surface or the like of the straight body portion 21.

A boundary line in the horizontal direction between the substantially cylindrical straight body portion 21 and the curved bottom portion 22 is also referred to as a tangent line TL. In addition, a distance L in the vertical direction between the lowermost portion of the stirring tank 2 (bottom portion 22) and the surface or liquid level LL of the fluid F in the stirring tank 2 is also referred to as liquid level height or reference height. In the example of the present embodiment, the liquid level height L of the fluid F in the axial direction is larger than the tank diameter D of the stirring tank 2 in the radial direction. Such a vertically elongated stirring tank 2 is preferable for forming a flow (schematically shown by arrows in FIG. 1) of the fluid F that largely circulates in the substantially up-down direction by the rotation of the stirring blade 3 and/or a circulation unit 33 to be described below. In a case where the bottom portion 22 is formed in a flat shape, the distance L in the vertical direction between the flat bottom portion 22 (bottom plate) and the liquid level LL of the fluid F can be construed as the liquid level height.

The stirring blade 3 is provided to be rotatable around the rotary shaft 30 that substantially coincides with a center axis of the stirring tank 2 in the vertical direction. The stirring blade 3 is rotatably provided above the tangent line TL, that is, inside the straight body portion 21 of the stirring tank 2. Although not shown, a rotary drive unit such as a motor that generates rotational power or a rotational power conversion unit such as a speed changer or a reduction gear that converts the rotational power into a desired number of revolutions (or rotational speed) or torque may be provided above the rotary shaft 30. A lower bearing (not shown) may be provided below the rotary shaft 30. The rotational speed of the stirring blade 3 is optional. A detailed configuration of the stirring blade 3 will be described below.

The circulation unit 33 is provided at a lower portion of the stirring blade 3 (below plate-shaped members 311 to 314 to be described in detail below), preferably below the tangent line TL, that is, inside the bottom portion 22 of the stirring tank 2 to be rotatable around a rotary shaft that substantially coincides with the center axis of the stirring tank 2 in the vertical direction. The circulation unit 33 is separated from the stirring blade 3, and may be rotated independently of the stirring blade 3 by a rotary shaft (not shown) different from the stirring blade 3.

The circulation unit 33 receives a flow downward from an upper portion of the stirring blade 3 and discharges the flow to an outer peripheral side of the stirring tank 2. As a result, as schematically shown by arrows, an upward flow of the fluid F is formed along an inner peripheral wall of the stirring tank 2. When the upward flow rises to the vicinity of the liquid level LL, the upward flow is changed to a flow directed to the inner peripheral side of the rotary shaft 30, and further descends to be supplied to the upper portion of the stirring blade 3. The fluid F is stirred by the stirring blade 3 while descending, and then is circulated in the stirring tank 2 by the circulation unit 33 again. The circulation unit 33 for generating such a circulation flow can be configured by, for example, any discharge type flow blade such as a paddle blade, a turbine blade, or a backward blade. The circulation unit 33 may be continuously formed integrally with lower portions of the plate-shaped members 311 to 314, which will be described in detail below.

In another embodiment of FIG. 2, an external circulation mechanism 42 such as a pump that circulates the fluid F outside the stirring tank 2 is provided instead of the circulation unit 33 for generating the circulation flow in the stirring tank 2 in one embodiment of FIG. 1. As schematically shown by arrows in FIG. 2, the fluid F that is stirred by the stirring blade 3 while descending is extracted from the bottom portion 22 of the stirring tank 2 to the outside of the stirring tank 2. The fluid F is lifted to an upper portion of the straight body portion 21 of the stirring tank 2 through the external circulation mechanism 42 such as a pump, is re-introduced into the stirring tank 2, and is supplied to the stirring blade 3 again.

In still another embodiment of FIG. 3, instead of circulating the fluid F inside and outside the stirring tank 2 by the circulation unit 33 in one embodiment of FIG. 1, the external circulation mechanism 42 in another embodiment of FIG. 2, or the lie, the fluid F flows only once in principle in a specific direction from one end to the other end of the stirring tank 2 that is elongated in the axial direction. In the example of FIG. 3, the stirring tank 2 has a substantially cylindrical or substantially tubular shape that is elongated in the axial direction. It is preferable that the center axis of the stirring tank 2 coincides with the rotary shaft 30 of the stirring blade 3.

A first fluid port 23 through which the fluid F can pass in one direction in principle is provided in the flat bottom portion 22 (that is, a bottom surface) of the stirring tank 2, and a second fluid port 25 through which the fluid F can pass in one direction in principle is provided in a flat top portion 24 (that is, a top surface) of the stirring tank 2. In the example of FIG. 3, the first fluid port 23 is a fluid feed port through which the fluid F is continuously supplied upward, and the second fluid port 25 is a fluid discharge port from which the fluid F is continuously discharged upward. Since the fluid F is continuously supplied and discharged in a specific direction, the method of the stirring tank 2 or the stirring device 1 may be expressed as a continuous type.

The fluid F enters the stirring tank 2 through the first fluid port 23 and is stirred by the stirring blade 3 until the fluid F exits the stirring tank 2 through the second fluid port 25. The stirring blade 3 is elongated in the axial direction similarly to the stirring tank 2, and has a height H that covers substantially the entire (for example, 90% or more) axial length (that is, the height) of the stirring tank 2. As will be described below, the stirring blade 3 in the example of the present embodiment is configured by an elongated plate-shaped member extending in the axial direction. However, the height H of the entire stirring blade 3 may be covered by a single plate-shaped member having substantially the height H, or the height H of the entire stirring blade 3 may be covered by disposing a plurality of plate-shaped members having a height h significantly smaller than the height H side by side in the axial direction as schematically shown in FIG. 3. These plate-shaped members can be rotated around a common rotary shaft 30 regardless of the height or the number of the plate-shaped members.

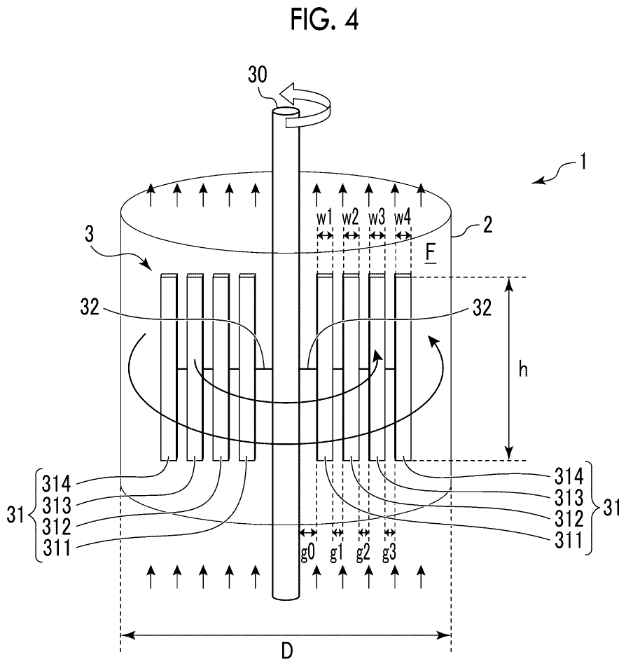

FIG. 4 schematically shows one small stirring blade 3 in a case where the stirring blade 3 having the height H is configured by a combination of a plurality of small stirring blades 3 having a height h as in FIG. 3 (although not shown, substantially the same small stirring blades 3 are aligned above and/or below the single small stirring blade 3 in the axial direction). The following description of the small stirring blade 3 (hereinafter, referred to as the stirring blade 3 for convenience) also applies to the stirring blade 3 in the circulation type stirring device 1 shown in FIGS. 1 and 2.

The stirring blade 3 includes a plurality of plate-shaped members 311 to 314 that are rotatable in a circumferential direction (rotating direction perpendicular to the axial direction and the radial direction) around the rotary shaft 30 at different radial positions in the radial direction (left-right direction in FIG. 4) perpendicular to the axial direction (up-down direction in FIG. 4) in which the rotary shaft 30 extends. Each of the plurality of plate-shaped members 311 to 314 extends substantially parallel to each other in the axial direction. In the example of FIG. 4, stirring units 31 each including four plate-shaped members 311 to 314 are provided on each of the left side and the right side of the rotary shaft 30.

The number of the stirring units 31 is optional, and as shown in FIG. 4, two stirring units 31 may be provided, or one stirring unit 31 may be provided, or three or more stirring units 31 may be provided. It is preferable that the plurality of stirring units 31 are disposed at the circumferential positions (angles) that are point-symmetric with respect to the rotary shaft 30 in the axial view (top view or bottom view in FIG. 4) to generate the flow of the fluid F having a homogeneous flow as much as possible in the stirring tank 2.

For example, in a case where two stirring units 31 are provided, as shown in FIG. 4, the two stirring units 31 are preferably disposed at circumferential positions (for example, a 0° position and a 180° position) that are point-symmetric with respect to the rotary shaft 30. In addition, in a case where four stirring units 31 are provided, the four stirring units 31 are preferably disposed at circumferential positions (for example, a 0° position, a 90° position, a 180° position, and a 270° position) that are point-symmetric with respect to the rotary shaft 30. In a case where an even number of stirring units 31 are provided as described above, as shown in FIG. 4, it is preferable that two stirring units 31 on opposite sides are configured to be line-symmetrical with respect to the rotary shaft 30 in a plane including the rotary shaft 30.

The plurality of plate-shaped members 311 to 314 constituting each stirring unit 31 are connected to each other by a rod-shaped connection member 32 extending in the radial direction, and are integrally rotatable around the rotary shaft 30. The connection member 32 is preferably as thin as possible not to hinder the flow of the fluid F mainly generated by the plate-shaped members 311 to 314.

The shape or the dimension of each of the plate-shaped members 311 to 314 in each of the stirring units 31 is optional, but it is preferable that the height h in the axial direction and the thickness in the circumferential direction are common to all the plate-shaped members 311 to 314. On the other hand, radial widths w1 to w4 of the respective plate-shaped members 311 to 314 may be the same as or different from each other. In addition, radial spacings g1 to g3 between the plate-shaped members 311 to 314 and/or a radial spacing g0 (zero in a case where a first plate-shaped member 311 protrudes directly from the rotary shaft 30) between a first plate-shaped member 311 on the innermost peripheral side and the rotary shaft 30 may be the same as each other or different from each other. The three-dimensional dimensions, the spacings, the radial positions, and the like of the plurality of plate-shaped members 311 to 314 in each of the stirring units 31 as described above are preferably adjusted or optimized based on fluid analysis or the like such as computational fluid dynamics (CFD) so that a desired flow to be described below is generated.

In addition, as in the example of FIG. 3, in a case where the small stirring blades 3 as shown in FIG. 4 are disposed side by side in the axial direction, the configurations of the plurality of small stirring blades 3 disposed at different axial positions may be substantially the same or different from each other over all the small stirring blades 3. In addition, even in a case where the three-dimensional dimensions, the spacings, the radial positions, and the like of the plurality of plate-shaped members 311 to 314 constituting each stirring unit 31 are substantially the same for all the small stirring blades 3, the radial positions at which the respective stirring units 31 are provided may be different, for example, between two small stirring blades 3 adjacent to each other in the axial direction.

For example, in one small stirring blade 3 including the two stirring units 31 as shown in FIG. 4, each of the stirring units 31 is disposed at each of a 0° position and a 180° position in the axial view. In this case, for example, in a small stirring blade 3 (not shown) located above each one small stirring blade 3, the two stirring units 31 may be disposed at circumferential positions (for example, a 90° position and a 270° position, a 45° position and a 225° position, and the 30° position and the 210° position) different (or deviated) from the 0° position and the 180° position in the axial view. The deviations or the offsets (for example, 90°, 45°, 30°) in rotational position between the small stirring blades 3 that are different from each other can also be adjusted or optimized based on CFD or the like so that a desired flow to be described below is generated.

In FIG. 4, the fluid F supplied from below (another small stirring blade 3 or the first fluid port 23, which is not shown) is sheared or atomized by the shown small stirring blade 3 that is rotationally driven, and is further sent upward (another small stirring blade 3 or the second fluid port 25, which is not shown). A flow of the fluid F generated by the stirring blade 3 rotating in this way can be simulated by fluid analysis based on CFD or the like.

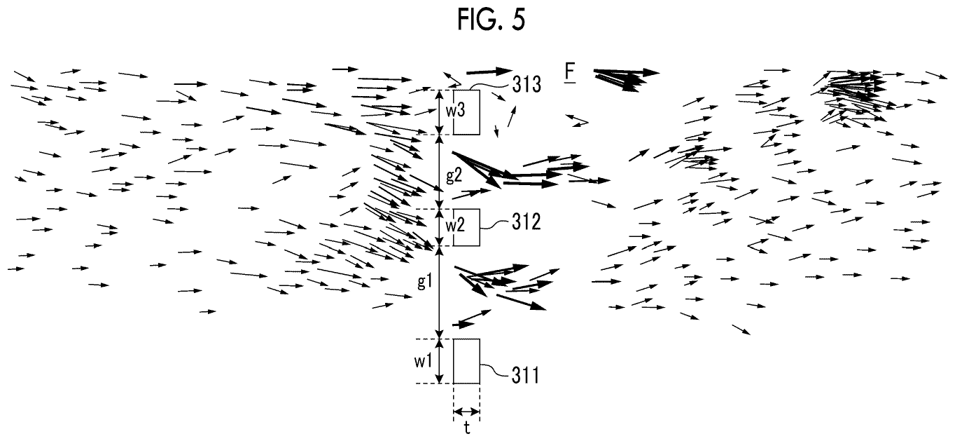

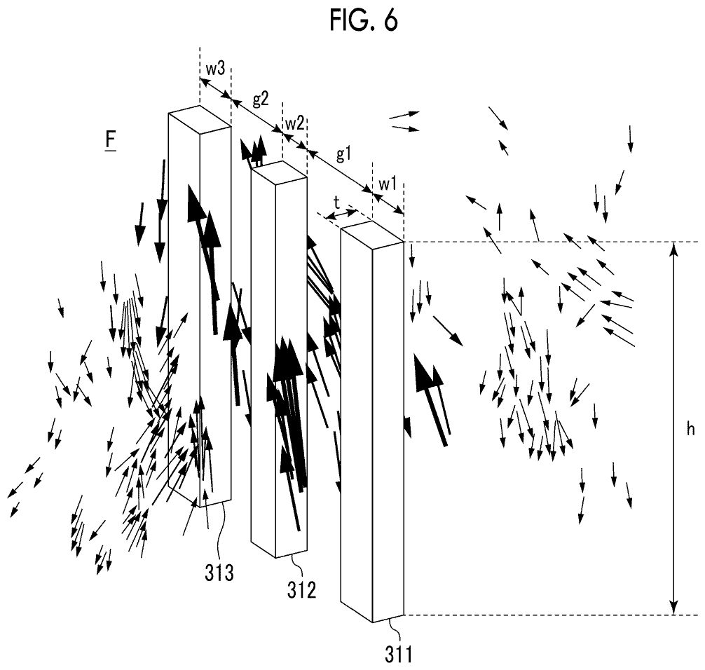

FIGS. 5 and 6 show simulation examples of the flow of the fluid F by CFD. FIG. 5 is a view in which the velocity of the flow of the fluid F is visualized by arrows (vectors) in a cross section in which the axial direction is a normal direction. In this simulation example, the three plate-shaped members 311 to 313 are disposed side by side in the radial direction (up-down direction in FIG. 5), and are rotationally driven in the circumferential direction (leftward direction in FIG. 5), so that a rightward flow of the fluid F is generated. The fluid F flows into two gaps (hereinafter, also referred to as slits) between the three plate-shaped members 311 to 313 from the left in FIG. 5. In this case, since the flow velocity is increased, arrows indicating the velocity are locally increased inside each gap and/or at the outlet of each gap.

FIG. 6 is a view in which the vortexes of the fluid F generating the three plate-shaped members 311 to 313 (having a common height h and a common thickness t) similar to FIG. 5 are visualized by arrows (vorticity, which is a vector). It can be seen that locally large vortexes are generated when the fluid F passes through the two slits of the three plate-shaped members 311 to 313.

In the present embodiment, the above-described CFD was used to find a numerical index for allowing the stirring blade 3 to efficiently stir or shear the fluid F in a case where the target is limited to a flow region where the Reynolds number is 300 or more. In addition, it was confirmed that the stirring blade 3 satisfying the numerical index can be actually designed by using CFD. In particular, it was confirmed that the stirring blade 3 satisfying the numerical index can be actually designed by adjusting various parameters (for example, the height h, the thickness t, the width w1 to w4, and the spacings g0 to g3 of each plate-shaped member) shown in FIGS. 4 to 6.

Here, the Reynolds number Re is defined by the following expressions using the density p [kg/m³] of the fluid F, the number of revolutions n [1/s] of the stirring blade 3, the blade diameter d [m] of the stirring blade 3, and the viscosity μ [Pa·s] of the fluid F.

$$R e = \frac{ρ n {d}^{2}}{μ}$$

Specifically, in the present embodiment, a velocity gradient tensor ∇u of the fluid F, and a deformation rate tensor E and a rotational speed tensor Ω, which are components of the velocity gradient tensor, were focused on in CFD. The velocity gradient tensor ∇u of the fluid F is a sum of the deformation rate tensor E and the rotational speed tensor 22 (that is, ∇u=E+Ω). In the shearing or atomization of the fluid F, the deformation rate tensor E that governs the deformation of the particles of the fluid F is important. For this reason, it is considered to be important to increase the ratio of the deformation rate tensor E (that is, to decrease the ratio of the rotational speed tensor Ω) in the velocity gradient tensor ∇u, which is the sum of the deformation rate tensor E and the rotational speed tensor Ω.

In the present embodiment, the ratio of such a deformation rate tensor E is defined by the following expression.

$$0 \underline{\leq } \frac{2}{π} {tan}^{- 1} ( \frac{‖ E ‖}{‖ Ω ‖} ) ≦ 1$$

The ratio is a numerical value between 0 and 1, and the larger the ratio (that is, the closer to 1), the more the deformation rate tensor E is dominant. In the present embodiment, the stirring blade 3 having a desired shearing performance was realized by focusing on fluid particles (or each region in the fluid F) having the ratio of 0.8 or more in CFD.

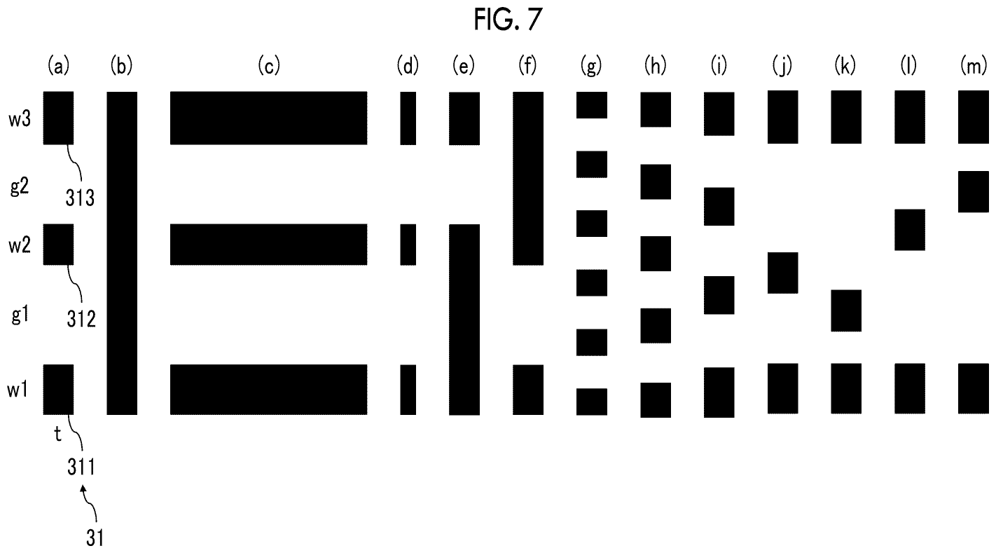

FIG. 7 schematically shows 13 test cases (a) to (m) of the number, dimensions, disposition, and the like of one or a plurality of plate-shaped members in each of the stirring units 31 constituting the stirring blade 3. In the drawing, the up-down direction is the radial direction, and the rotary shaft 30 (not shown) is present below. In addition, the left-right direction in the drawing is the circumferential direction in which the stirring unit 31 is rotationally driven. Black rectangles in each of the test cases (a) to (m) schematically show plate-shaped members.

For example, the stirring unit 31 of the test case (a) includes three plate-shaped members 311 to 313 in order from an inner peripheral side (lower side in FIG. 7) close to the rotary shaft 30. The plate-shaped members 311 to 313 have a common thickness t (for example, 3 mm) and widths w1 to w3 slightly different from each other (for example, w2<w1<w3). In addition, the two spacings g1 and g2 of the three plate-shaped members 311 to 313 in the radial direction are such that the spacing g1 (for example, 9 mm to 11 mm) on the inner peripheral side close to the rotary shaft 30 is larger than the spacing g2 (for example, 7 mm to 9 mm) (that is, g1>g2) on an outer peripheral side.

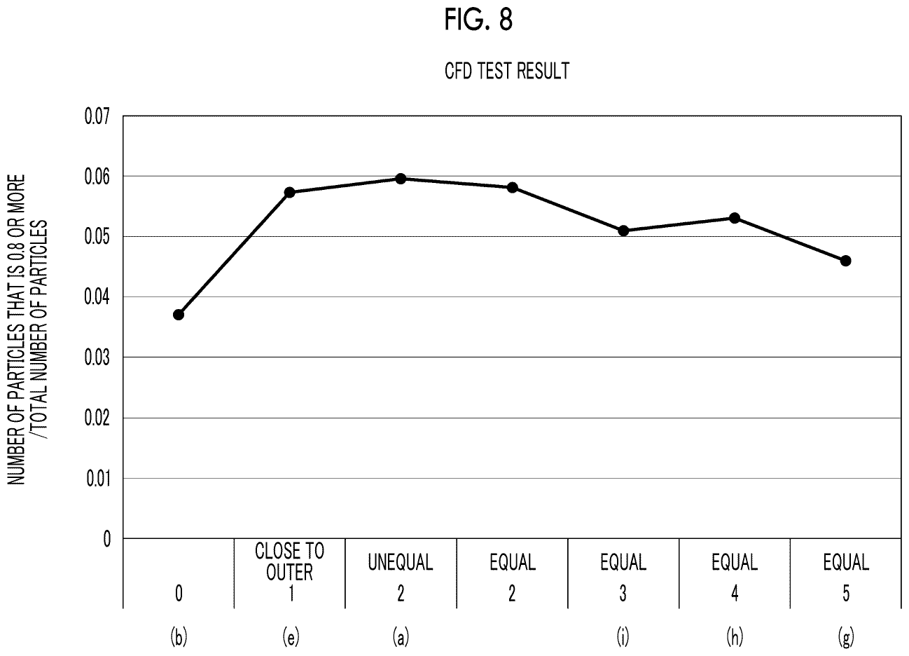

FIG. 8 shows the results of simulation by CFD for a representative test case as shown in FIG. 7. A typical diameter of the particles of the fluid F in the simulation was set to 1 mm to 2 mm. On a horizontal axis, each test case is classified according to the number and the disposition of slits. The stirring unit 31 with “0” slit corresponds to the test case (b) in which no slit is provided in FIG. 7. The stirring unit 31 with a “CLOSE TO OUTER 1” slit corresponds to the test case (e) in which one slit is positioned closer to the outer peripheral side in FIG. 7. In addition, although not shown, the same test result as that of the test case (e) was obtained also in the test case (f) in which one slit is positioned closer to the inner peripheral side in FIG. 7.

The stirring unit 31 with “UNEQUAL 2” slits corresponds to the test case (a) in which two slits are disposed at different spacings g1 and g2 in FIG. 7. In addition, although not shown, the same test result as that of the test case (a) was obtained also in the test case (d) in which the thickness t is smaller than that of the test case (a) (for example, about 1.5 mm that is half of about 3 mm in the test case (a)). In addition, although not shown, the same test result as that of the test case (a) was obtained for the test cases (j) to (m) in which the unequal disposition of the two slits is different from that of the test case (a).

The stirring unit 31 with “EQUAL 2” slits is not shown in FIG. 7, but is obtained by making the spacings g1 and g2 of the two slits in the test case (a) equal to each other. The stirring unit 31 with “EQUAL 3” slits corresponds to the test case (i) in which three slits are disposed with substantially equal spacings in FIG. 7. The stirring unit 31 with “EQUAL 4” slits corresponds to the test case (h) in which four slits are disposed with substantially equal spacings in FIG. 7. The stirring unit 31 with “EQUAL 5” slits corresponds to the test case (g) in which five slits are disposed with substantially equal spacings in FIG. 7.

A vertical axis in FIG. 8 shows the ratio of fluid particles in which the ratio of the above-mentioned deformation rate tensor E is 0.8 or more (or the region in the flow of the fluid F where the ratio of the deformation rate tensor E is 0.8 or more) out of all particles included in the flow of fluid F with a Reynolds number of 300 or more (or the entire region in the flow of the fluid F having a Reynolds number of 300 or more). As described above, the fluid particles in which the ratio of the deformation rate tensor E is 0.8 or more play a dominant role in the shearing or the atomization of the fluid F. Therefore, the higher the ratio, the higher the shearing performance or the atomization performance of the stirring unit 31 or the stirring blade 3.

As shown in FIG. 8, in the test case (e) (and the test case (f)) corresponding to the “CLOSE TO OUTER 1”, the test case (a) (and the test cases (d), (j), (k), (l), and (m)) corresponding to the “UNEQUAL 2”, the test case corresponding to the “EQUAL 2”, the test case (i) corresponding to the “EQUAL 3”, and the test case (h) corresponding to the “EQUAL 4”, the fluid particles in which the ratio of the deformation rate tensor E is 0.8 or more can be realized in a high percentage of 5% (0.05) or more in the flow of the fluid F having a Reynolds number of 300 or more.

As described above, it was found that, in a case where the number of slits provided in the stirring unit 31 is one or more and four or less, that is, in a case where the number of plate-shaped members provided in the stirring unit 31 is two or more and five or less, the ratio of fluid particles in which the ratio of the deformation rate tensor E is 0.8 or more can be increased, so that the stirring blade 3 having a higher shearing performance can be realized. It is considered that, in a case where the number of slits provided in the stirring unit 31 is five or more, that is, in a case where the number of plate-shaped members provided in the stirring unit 31 is six or more, the width of each slit becomes narrower, so that the particles of the fluid F cannot efficiently pass through the slits and the ratio of the deformation rate tensor E is not sufficiently increased.

In addition, in the above test cases (a), (d), (e), (f), (h), (i), (j), (k), (l), and (m) in which a higher shearing performance was obtained, it was confirmed that the spacing in the radial direction between a set of two plate-shaped members adjacent to each other in the radial direction (up-down direction in FIG. 7) is adjusted to 1.5 times to 2.5 times the width of at least one of the plate-shaped members in the radial direction and that this is important in increasing the ratio of the fluid particles in which the ratio of the deformation rate tensor E is 0.8 or more.

Furthermore, in the above test cases (a), (d), (e), (f), (h), (i), (j), (k), (l), and (m) in which a higher shearing performance was obtained, it was confirmed that the thickness t of each plate-shaped member in the circumferential direction (left-right direction in FIG. 7) is adjusted to 2% to 10% of the total width (for example, 30 mm to 40 mm) of the stirring unit 31 or the stirring blade 3 in the radial direction (up-down direction in FIG. 7) and that this is important in increasing the ratio of the fluid particles in which the ratio of the deformation rate tensor E is 0.8 or more. Although not shown, in the test case (c) in FIG. 7 in which the thickness t is large out of the adjustment range thereof, energy loss occurs when the fluid F passes through a thick slit in the circumferential direction, so that the ratio of the fluid particles in which the ratio of the deformation rate tensor E is 0.8 or more is insufficient (less than 5%).

Among the test cases in which a higher shearing performance was obtained, in particular, in the test case (e) (and the test case (f)) corresponding to “CLOSE TO OUTER 1”, the test case (a) (and the test cases (d), (j), (k), (l), and (m)) corresponding to “UNEQUAL 2”, and the test cases corresponding to “EQUAL 2”, the fluid particles in which the ratio of the deformation rate tensor E is 0.8 or more can be realized in a significantly high percentage of 5.35% (0.0535) to 5.70% (0.0570) in the flow of the fluid F having a Reynolds number of 300 or more.

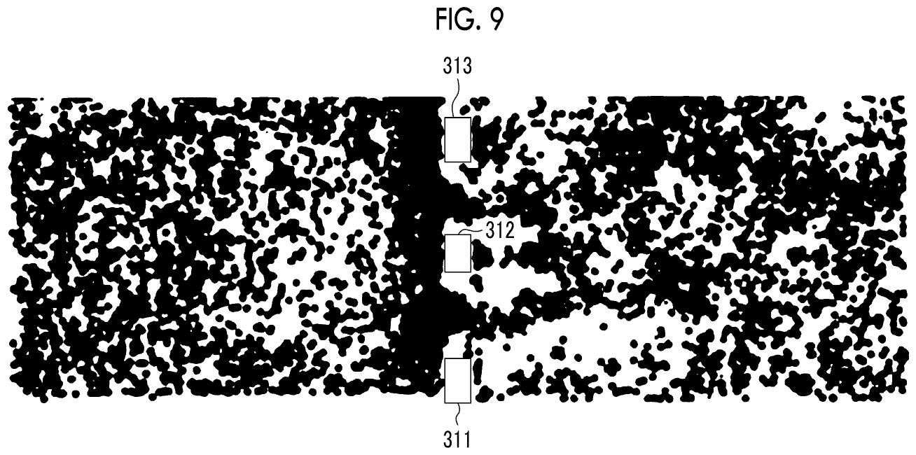

FIG. 9 schematically shows a distribution example of fluid particles in which the ratio of the deformation rate tensor E observed or simulated in the preferable test case (a) in FIG. 7 is 0.8 or more. One plot in this figure represents one fluid particle of which the ratio of the deformation rate tensor E is 0.8 or more. As described above, the ratio of the fluid particles in which the ratio of the deformation rate tensor E is 0.8 or more is relatively small, which is slightly more than 5% of the total in the test case (a). In the example of FIG. 9, although it seems that the fluid particles in which the ratio of the deformation rate tensor E is 0.8 or more are distributed significantly more than 5%, this is because fluid particles observed in different regions in the axial direction (a direction perpendicular to the paper surface in FIG. 9) are superimposed.

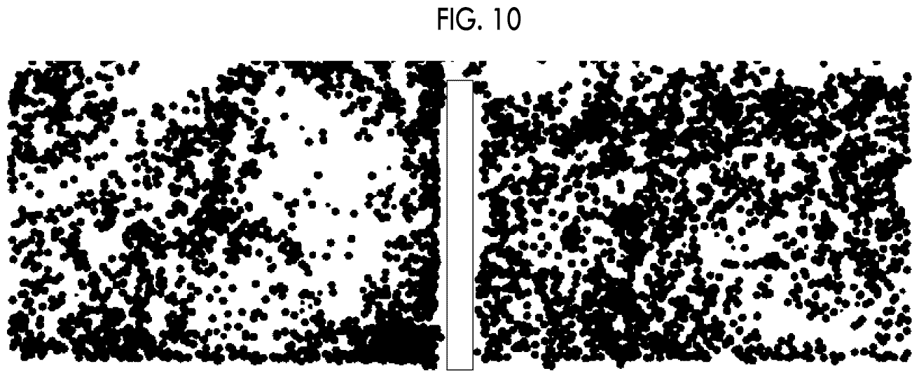

FIG. 10 schematically shows a distribution example of fluid particles in which the ratio of the deformation rate tensor E observed or simulated in the unfavorable test case (b) in FIG. 7 is 0.8 or more. It can be seen that the number of fluid particles in which the ratio of the deformation rate tensor E is 0.8 or more is remarkably small as compared to the preferable test case (a) of FIG. 9. As described above, according to the preferable test case (a) and the like, the ratio of the fluid particles in which the ratio of the deformation rate tensor E in the flow of the fluid F is 0.8 or more can be remarkably increased, and the stirring performance or the shearing performance of the stirring unit 31 or the stirring blade 3 can be remarkably increased.

In the above example, the flow region having a Reynolds number of 300 or more is targeted. However, the stirring blade 3 or the stirring device 1 according to the present disclosure can also be applied to a flow region having a Reynolds number of 1000 or more.

The present disclosure has been described based on the embodiments. Various modification examples are possible in combinations of respective components and respective processes in the embodiments as examples, and it is obvious to those skilled in the art that such modification examples are included in the scope of the present disclosure.

The configurations, actions, and functions of each device and each method described in the embodiments can be realized by hardware resources or software resources, or by the cooperation between hardware resources and software resources. As the hardware resources, for example, processors, ROMs, RAMs, and various integrated circuits can be used. As the software resources, for example, programs such as operating systems and applications can be used.

It should be understood that the invention is not limited to the above-described embodiment, but may be modified into various forms on the basis of the spirit of the invention. Additionally, the modifications are included in the scope of the invention.

What is claimed is:

1. A stirring blade that stirs a fluid by rotating around a rotary shaft,
wherein a flow of the fluid in which a Reynolds number is 300 or more and a ratio of a deformation rate tensor with respect to a velocity gradient tensor of the fluid that is a sum of the deformation rate tensor and a rotational speed tensor is 0.8 or more in a region of 5% or more in the flow is generated.

2. The stirring blade according to claim 1,
wherein a flow of the fluid in which the Reynolds number is 1000 or more and the ratio of the deformation rate tensor with respect to the velocity gradient tensor is 0.8 or more in the region of 5% or more in the flow is generated.

3. The stirring blade according to claim 1,
wherein a flow of the fluid in which the Reynolds number is 300 or more and the ratio of the deformation rate tensor in the velocity gradient tensor is 0.8 or more in a region of 5.35% to 5.70% in the flow is generated.

4. The stirring blade according to claim 1, comprising:
a plurality of plate-shaped members that are rotatable at different positions in a radial direction perpendicular to an axial direction in which the rotary shaft extends.

5. The stirring blade according to claim 4,
wherein the plurality of plate-shaped members are rotatable around a common rotary shaft.

6. The stirring blade according to claim 5,
wherein each of the plurality of plate-shaped members extends parallel to each other in the axial direction.

7. The stirring blade according to claim 4,
wherein a stirring unit including the plurality of plate-shaped members is provided at a circumferential position of the rotary shaft.

8. The stirring blade according to claim 7,
wherein the stirring unit is provided on both a left side and a right side of the rotary shaft.

9. The stirring blade according to claim 8,
wherein the plurality of plate-shaped members constituting each stirring unit are connected to each other by a rod-shaped connection member extending in the radial direction, and are integrally rotatable around the rotary shaft.

10. The stirring blade according to claim 4, comprising:
two or more and five or less of the plate-shaped members rotatable at two or more and five or less different radial positions.

11. The stirring blade according to claim 4,
wherein a spacing in the radial direction between a set of two plate-shaped members adjacent to each other in the radial direction is 1.5 times to 2.5 times a width of at least one of the plate-shaped members in the radial direction.

12. The stirring blade according to claim 4,
wherein a thickness of each of the plate-shaped members in a circumferential direction perpendicular to the axial direction and the radial direction is 2% to 10% of a total width of the stirring blade in the radial direction.

13. The stirring blade according to claim 4, further comprising:
at least three plate-shaped members that are rotatable at least three different radial positions,
wherein a spacing between at least three of the plate-shaped members in the radial direction is larger on an inner peripheral side closer to the rotary shaft.

14. The stirring blade according to claim 4,
wherein each of the plurality of plate-shaped members extends in the axial direction.

15. A stirring blade that stirs a fluid by rotating around a rotary shaft, the stirring blade comprising:
two or more and five or less plate-shaped members that are rotatable at two or more and five or less different positions in a radial direction perpendicular to an axial direction in which the rotary shaft extends,
wherein a spacing in the radial direction between a set of two plate-shaped members adjacent to each other in the radial direction is 1.5 times to 2.5 times a width of at least one of the plate-shaped members in the radial direction.

16. The stirring blade according to claim 15,
wherein a circulation unit rotatable around the rotary shaft is provided below the plate-shaped members.

17. A stirring device comprising:
a stirring blade that stirs a fluid contained in a stirring tank by rotation,
wherein the stirring blade generates, within the stirring tank, a flow of the fluid in which a Reynolds number is 300 or more and a ratio of a deformation rate tensor with respect to a velocity gradient tensor of the fluid that is a sum of the deformation rate tensor and a rotational speed tensor is 0.8 or more in a region of 5% or more in the flow.

18. A stirring method of stirring a fluid contained in a stirring tank by rotation of a stirring blade,
wherein a flow of the fluid in which a Reynolds number is 300 or more and a ratio of a deformation rate tensor with respect to a velocity gradient tensor of the fluid that is a sum of the deformation rate tensor and a rotational speed tensor is 0.8 or more in a region of 5% or more in the flow is generated within the stirring tank by the stirring blade.
